(19) United States
(12) Patent Application Publication
(10) Pub. No.: US 2014/0035351 A1
(43) Pub. Date: Feb. 6, 2014

(54) Wheel Bearing Assembly of a Vehicle

(71) Applicant: Bayerische Motoren Werke Aktiengesellschaft, Muenchen (DE)

(72) Inventors: Roland SCHMIDT, Stockdorf (DE); Johann DUDKOWIAK, Poecking (DE)

(73) Assignee: Bayerische Motoren Werke Aktiengesellschaft, Muenchen (DE)

(21) Appl. No.: 14/051,038

(22) Filed: Oct. 10, 2013

Related U.S. Application Data
(63) Continuation of application No. PCT/EP2012/054838, filed on Mar. 19, 2012.

(30) Foreign Application Priority Data
Apr. 11, 2011 (DE) 10 2011 007 110.5

(51) Int. Cl. B60B 27/00

(52) U.S. Cl. CPC B60B 27/0005
USPC 301/110

(57) ABSTRACT

A wheel bearing assembly of a vehicle is provided. A hub is mounted via a roller bearing arrangement in a wheel carrier. The hub has a driving flange with a bearing surface which is perpendicular to the axis of rotation of the wheel, optionally with the intermediate positioning of a brake disk, such that the bearing surface of the driving flange describes a plane that intersects the roller bearing arrangement. The hub forms or supports an inner ring of the roller bearing arrangement, and an outer ring of the roller bearing assembly is held in the wheel carrier. A support structure for the driving flange is guided around the roller bearing arrangement on the outside of the wheel bearing assembly, facing away from the vehicle body and wheel carrier. As a result, a wheel insertion depth in the order of zero or a few millimeters may be achieved.

### CROSS REFERENCE TO RELATED APPLICATIONS

This application is a continuation of PCT International Application No. PCT/EP2012/054838, filed Mar. 19, 2012, which claims priority under 35 U.S.C. §119 from German Patent Application No. DE 10 2011 007 110.5, filed Apr. 11, 2011, the entire disclosures of which are expressly incorporated by reference herein.

### BACKGROUND AND SUMMARY OF THE INVENTION

The invention relates to a wheel bearing assembly that is designed, in particular, for a two track vehicle and comprises a hub, which is mounted in a wheel carrier by a roller bearing arrangement and has a driving flange with a bearing surface, which is perpendicular to the rotational axis of the wheel, for a wheel, optionally with intermediate positioning of a brake disk. With respect to the prior art, reference is made not only to German patent publications DE 102 59 156 A1 and DE 10 2009 014 879 A1 but also, in particular, to German patent publications DE 103 59 643 A1 or DE 40 38 917 C1.

The two latter publications show the basic construction of standard modern wheel bearing arrangements in two track motor vehicles, according to which the wheel hub forms or carries an inner ring of the roller bearing arrangement, while an outer ring of the roller bearing arrangement is held in a so called wheel carrier (or the like), which is guided relative to the vehicle body by way of control arms. A so called driving flange is usually formed in one piece on the hub; and the wheel of the vehicle rests against this driving flange and is usually fastened on said driving flange in such a way that said wheel is also detachable. In most cases a brake disk is also fastened on this driving flange, so that in a conventional design the bottom of the so called brake disk chamber may be found between the driving flange and the wheel, more precisely the wheel disk or a wheel ring flange that connects the radially inner ends of the wheel spokes. When viewed in the axial direction, the driving flange is located on the outside of the wheel bearing assembly and, in particular, is spaced a certain distance from the roller bearing arrangement.

With such a conventional wheel bearing arrangement there is a so called insertion depth, which may well be in an order of magnitude of 30 millimeters to 45 millimeters, when rims are used that are conventional at least on passenger vehicles and/or when wheels are used that exhibit the standard rim dimensions. The insertion depth is commonly defined as the distance between the rim center (measured between the rim flanges) and the inner bearing surface on the wheel hub, measured in millimeters (citation from “Wikipedia”). Such a relatively high insertion depth is disadvantageous for reasons relating to strength, especially in the context of a lightweight design that is desired as a matter of principle and/or is also, in particular, the goal for the wheels.

While wheel bearing assemblies that enable an insertion depth in the order of zero or a few millimeters even with standard wheels are already known, for example, from German patent publication DE 102 59 156 A1, the hub in these arrangements that are known from the prior art differs from the present invention in that the prior art hub is not mounted (at least when viewed from the side, i.e. when viewed in the direction of the rotational axis of the wheel) in a wheel carrier that surrounds the hub (and/or inside a wheel carrier, when viewed in the radial direction), but rather the hub is mounted on a shaft journal, so that the hub surrounds the shaft journal or, when viewed in the radial direction, envelops the shaft journal and, in so doing, forms the outer ring of the roller bearing arrangement.

An object of the present invention is to provide for a wheel bearing assembly which reduces the insertion depth compared to the prior art.

The solution to this engineering object is characterized by the fact that the bearing surface of the driving flange describes a plane that intersects the roller bearing arrangement.

The driving flange, which is connected to the hub and which is preferably formed as one piece on the hub, is arranged and shaped, according to the invention, in such a way that the said bearing surface is located in a vertical plane, i.e. a plane that is perpendicular to the rotational axis of the wheel. Furthermore, this plane can form the roller bearing arrangement, i.e. typically at least one bearing inner ring, which can also be formed by a section of the hub, and intersects a bearing outer ring. Moreover, this plane intersects or is tangent at least approximately to either a row of roller bodies of the roller bearing arrangement, which usually comprises two rows of roller bodies; or this said plane is located between the two rows of roller bodies. Thus, the driving flange can be easily positioned in such a way that an insertion depth in an order of magnitude of zero or a few millimeters can be achieved with a customary wheel rim (with standard dimensions, for example, on passenger vehicles).

It has already been stated above that the hub can form or support an inner ring of the roller bearing arrangement, so that consequently an outer ring of the roller bearing arrangement is held in or on the wheel carrier. Then the above described situation of the bearing surface of the driving flange can be depicted in that a support structure for this exterior of the wheel bearing assembly that faces away from the vehicle body is guided around the roller bearing arrangement. Preferably this so called support structure forms a single component with the driving flange and the hub.

Even in the case of a wheel bearing assembly according to the invention, the wheel can be fastened, as is customary, with its wheel disk or with its spokes or more specifically with a ring flange, which connects the radially inner ends of the wheel spokes, on the driving flange by detachable fastening elements (screws, or threaded bolts with nuts).

In the context of a particular wheel unit, wherein only the so called rim tape is removed in order to change the wheel on the vehicle, whereas the wheel disk or a so-called rim star, disclosed in German patent publication DE 10 2009 014 879 A1, which was mentioned as an example in the introductory part of the present specification, stays on the wheel carrier or to be more precise on the hub or more specifically its driving flange, the fastening elements can be accessible from the side of the wheel bearing assembly that faces the vehicle body; and, as a result, said fastening elements are not visible on the exterior of the wheel bearing assembly, a feature that not only makes possible a novel design, but can also help to improve the air resistance of a vehicle that is equipped in such a way. As an alternative or in addition, with a wheel bearing assembly according to the invention the wheel disk or a ring flange, which connects the radially inner ends of the wheel spokes, can be screwed on the hub by means of a central screw or the like.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an inventive wheel bearing assembly with a wheel in a longitudinal sectional view that includes the rotational axis of the wheel, in accordance with an embodiment of the present invention;

FIG. 2a is an illustration of a conventional wheel bearing assembly of the prior art;

FIG. 2b shows a longitudinal sectional view of a wheel bearing assembly in accordance with an embodiment of the present invention, including wheel spokes and;

FIG. 3 is an exploded view of an additional embodiment of the present invention showing the region of the wheel bearing.

### DETAILED DESCRIPTION OF THE DRAWINGS

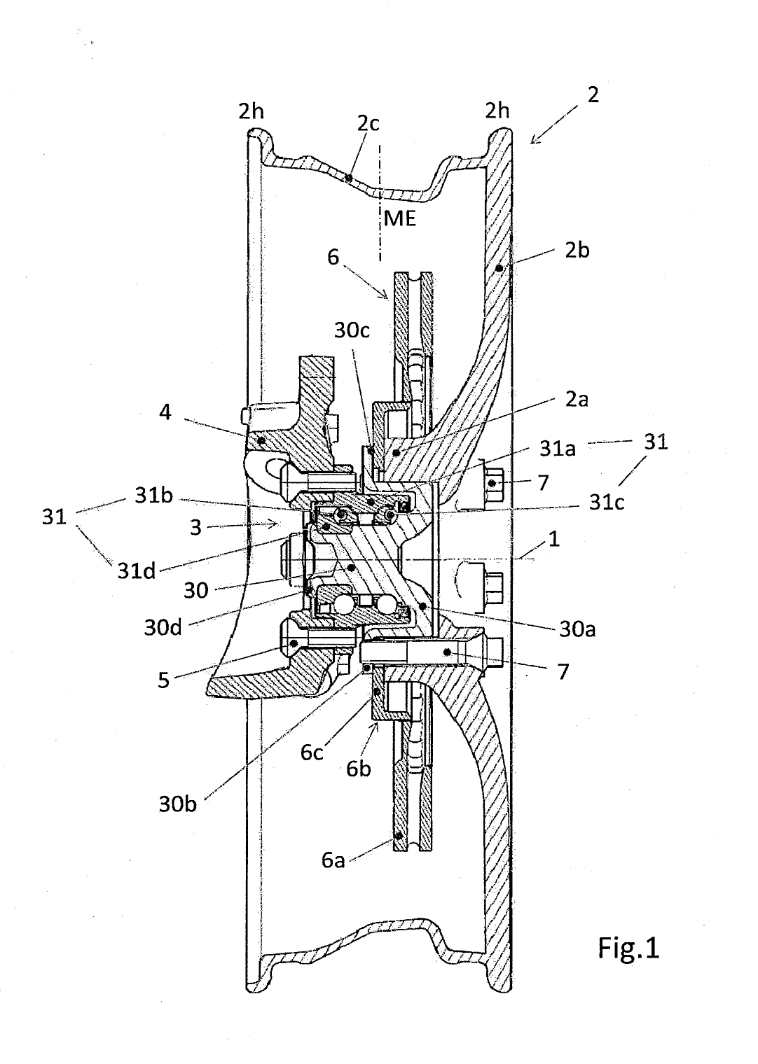

Referring to FIG. 1, the reference numeral 1 marks the rotational axis of a wheel 2, which is rotatably mounted on a wheel carrier 4 (of which only a portion is shown) of a passenger vehicle by a wheel bearing assembly 3. The term axial direction means a direction parallel to the rotational axis of the wheel; and the term radial direction means a direction that is perpendicular to the rotational axis of a wheel and that faces outwards so as to be directed away from the axis of rotation. The wheel bearing assembly 3 is formed by a hub 30 and a roller bearing arrangement 31. This roller bearing arrangement 31, which is configured in the form of a double row angular ball bearing, consists of a bearing outer ring 31a, which is detachably fastened on the wheel carrier 4 by fastening elements 5 that are aligned parallel to the axis of rotation 1, and consists of roller bodies 31b, 31c, which run in two rows in the outer ring 31a in the radial direction. Of these roller bodies, those of the first row (31b) run on a bearing inner ring 31d, which is fixed in a known manner on the hub 30, whereas the inner ring for the second row of roller bodies 31c is formed by a surface section of the hub 30 itself.

The hub 30 has more or less the shape of a circular cylinder in the region of the roller bearing arrangement 31. A support structure 30a, which merges into a driving flange 30b and/or supports said driving flange, is integrally connected to the said circular cylinder.

This driving flange 30b, which is aligned perpendicular to the axis of rotation 1 and has the shape of a circular ring disk, forms a bearing surface 30c for a brake disk 6 and, connected thereto, a ring flange 2a of the wheel 2. The outer surface of the circular ring disk, i.e. the surface of this circular ring disk, which is shown on the right hand side in the figure, faces away from the vehicle body, which is not shown, and, as a result, also faces away from the wheel carrier 4.

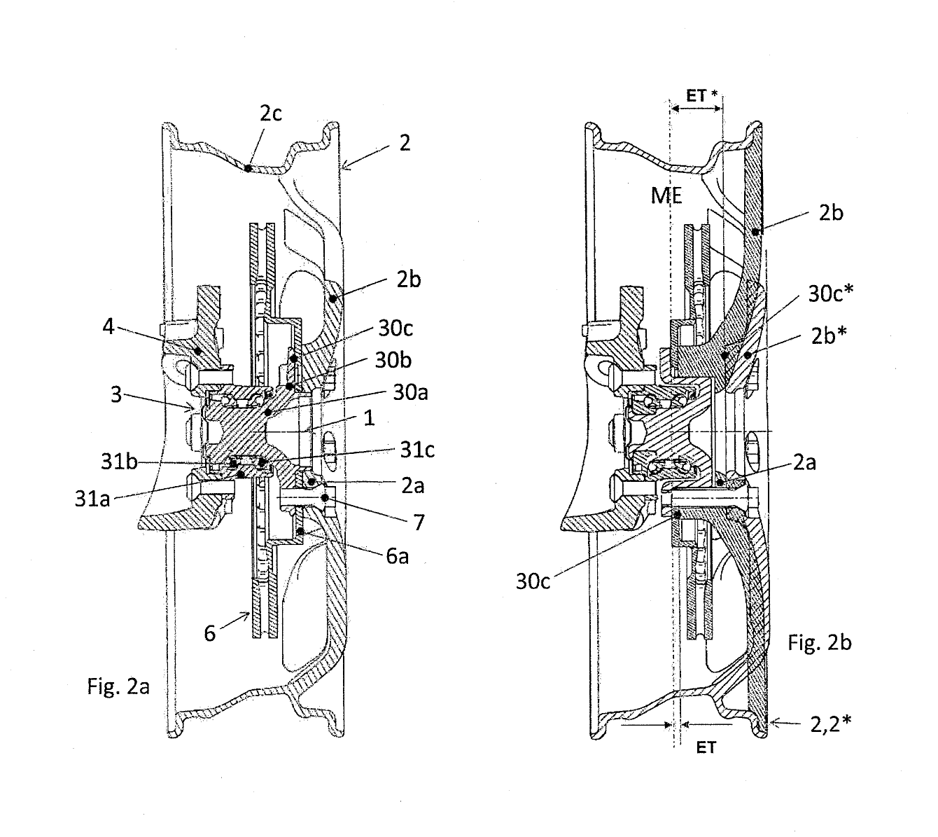

The wheel 2 is constructed basically in the customary way. That is, the rim 2c of the wheel 2 is supported by a plurality of suitably shaped spokes 2b, which extend in the radial direction and, in so doing, in the respective radial plane that includes the axis of rotation 1. The radially inner ends of the spokes, i.e. the ends that lie close to the hub 30, are connected to each other by the aforementioned ring flange 2a. The internally vented brake disk 6 is constructed basically in the standard way, but, as shown in FIG. 2, is built contrary to the conventional design.

The brake disk 6 consists of a double wall friction ring 6a, which is supported by a brake disk chamber 6b with a bottom that bears the reference numeral 6c.

Furthermore, referring to FIG. 1, the brake disk 6 is supported in a conventional manner by way of its bottom 6c by the hub 30 or more specifically by its support structure 30a and driving flange 30b, and is mounted, as usual, on the driving flange 30b, together with the ring flange 2a of the wheel 2 by fastening elements 7, here in the form of conventional wheel screws. At the same time the ring flange 2a is also supported, as usual, in the radial direction by the hub 30 and in this case by the support structure 30a. The support structure 30a for the driving flange 30b starts from the outside region of the central circularly cylindrical portion of the hub 30 and then extends outwards, as can be seen, in the radial direction and then subsequently extends towards the wheel carrier 4 or rather towards the vehicle body in the axial direction, so that it is guided on the outside around the roller bearing arrangement 31. As a result, the driving flange 30b, which is supported by the support structure 30a and aligned as described, can be positioned in such a way that the rim 2c of the illustrated wheel produces an insertion depth in the order of zero or a few millimeters. That is, the bearing surface 30c of the driving flange 30b lies in a plane perpendicular to the axis of rotation 1; and this plane intersects the rim 2c (approximately) in the center between the two rim flanges 2h.

Since in the present embodiment the bottom 6c of the brake disk chamber 6b is located in accordance with the conventional design between the internal end face (i.e. the end face facing the wheel carrier 4) of the central ring flange 2a of the wheel 2 and the bearing surface 30c of the driving flange 30b, it goes without saying that the bearing surface 30c has to be offset in the direction of the wheel carrier 4 from a center plane ME between the two rim flanges by the thickness of said bottom 6c, in order to achieve an insertion depth of exactly zero millimeters.

Yet even if an insertion depth of zero value is not achieved, it is still possible to achieve in a simple way a very small insertion depth in the order of a few millimeters in that the bearing surface 30c of the driving flange 30b describes a plane that intersects the roller bearing arrangement 31 (as described above).

In particular, it is especially clear from FIG. 2b that the insertion depth that can be achieved with a wheel bearing assembly according to the invention is considerably less than the insertion depth that can be achieved with a conventional wheel bearing assembly, which is shown in FIG. 2a. In other words, FIG. 2b shows the inventive wheel bearing assembly with the wheel 2, the wheel spokes 2b, the ring flange 2a and the bearing surface 30c of the driving flange according to FIG. 1 and, in addition, the wheel, which is shown in FIG. 2a and, to distinguish, is marked with reference numerals that are supplemented with a star. Therefore, the wheel is marked with the reference numeral 2*; the ring flange, with 2a*; the spokes, with 2b*; and the bearing surface of the driving flange of the arrangement from FIG. 2a is marked with the reference numeral 30c*. While it is clear that the insertion depth ET of the depicted wheel in the present embodiment is close to zero or rather in the order of a few millimeters with the present wheel bearing assembly according to the invention, the insertion depth, which is marked with the reference letters ET* and is in accordance with the state of the art (FIG. 2a), is of a significant magnitude and is greater than ET by about a factor of approximately 15. Furthermore, a comparison of the FIGS. 2a, 2b also shows that in the case of the wheel bearing assembly according to the invention (see embodiments in FIGS. 1, 2b) the brake disk 6 is installed contrary to the state of the art according to FIG. 2a, a feature that is supported by the available design space. While in the case of the state of the art (FIG. 2a) the brake disk chamber 6b is located on the side of the friction ring 6a that faces away from the wheel carrier 4, it is located on the side facing the wheel carrier 4 in the arrangement according to FIG. 1.

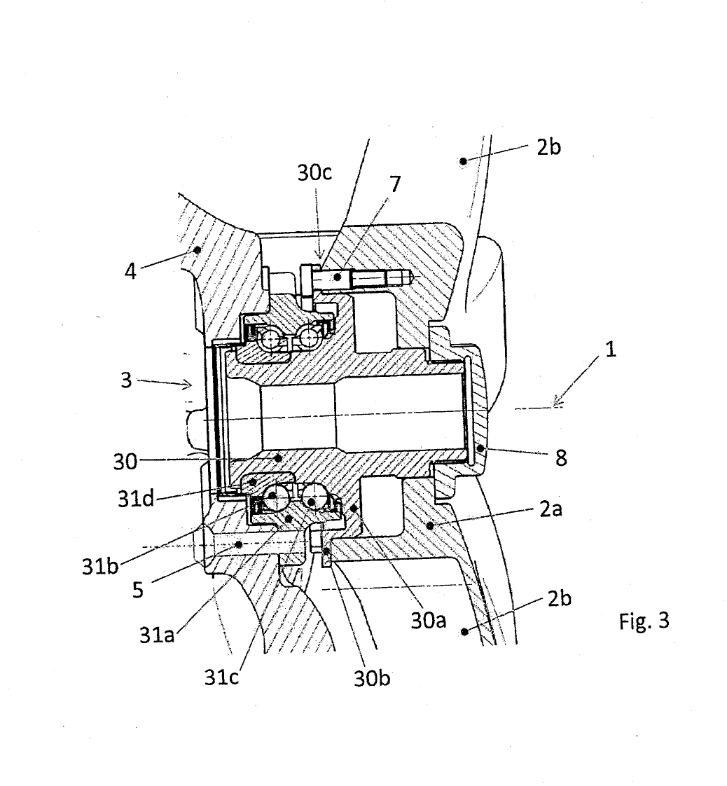

FIG. 3 shows an additional exemplary embodiment of a wheel bearing assembly according to the invention, wherein the wheel 2 or more precisely its ring flange 2a is mounted on the driving flange 30b, starting from the side facing the vehicle body or rather the wheel carrier 4, with only the fastening elements 7 that are accessible from this side. Hence, such a design lends itself well to a wheel unit, as shown, for example, in German patent publication DE 10 2009 014 879 A1, which is mentioned just before the description of the figure. In addition to these fastening elements 7, the ring flange 2a is secured from the outside by a central nut 8, which is mounted on the hub 30 that is suitably shaped for this purpose and is provided with a corresponding external thread. In this exemplary embodiment the plane, which is shown by the bearing surface 30c of the driving flange 30b, intersects only the outer ring 31a and the inner ring 31d of the roller bearing arrangement 31, where the inner ring (more precisely, the lateral contact shoulder) is formed by a surface section of the hub 30, whereas this said plane of the bearing surface 30c is tangent at least approximately to the row of roller bodies 31c.

Returning once again to FIG. 1, the hub 30 has an end face that faces the vehicle body. This end face of the hub is provided with a spur toothing system 30d or the like, for example, formed in the manner of a Hirth tooth system, for a positive locking connection with a wheel drive shaft that is not shown.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A wheel bearing assembly of a vehicle, comprising:
a hub having a driving flange portion with a bearing surface perpendicular to an axis of rotation a wheel of the vehicle; and
a roller bearing arrangement configured to be fixed to a wheel carrier, the roller bearing arrangement being configured to receive the hub mounted thereon;
wherein
the bearing surface of the driving flange portion of the hub lies in a plane intersecting the roller bearing arrangement,
the hub includes a bearing portion that at least one of forms or supports an inner ring of the roller bearing arrangement,
an outer ring of the roller bearing arrangement is configured to be held at least one of in and on the wheel carrier,
a support structure for the driving flange portion of the hub extends radially outboard of the roller bearing arrangement on a side of the hub facing away from the wheel carrier, and
the wheel bearing assembly is configured such that fastening elements of the wheel are accessible at the driving flange portion from a side of the wheel facing the wheel carrier such that the fastening elements are not visible from a side of the wheel facing away from the wheel carrier.

2. The wheel bearing assembly as claimed in claim 1, further comprising:
a brake disk configured to be positioned between the driving flange portion of the hub and the wheel of the vehicle.

3. The wheel bearing assembly as claimed in claim 1, wherein the driving flange portion is integrally formed on the hub.

4. The wheel bearing assembly as claimed in claim 1, wherein the driving flange portion is configured to be located on the roller bearing arrangement such that an insertion depth corresponding to a distance between an inner bearing flange of the wheel and a center distance between inner and outer flanges of the wheel is one of zero or a few millimeters.

5. The wheel bearing assembly as claimed in claim 1, wherein the hub is configured to permit the wheel to be secured by a central nut to the hub.

6. The wheel bearing assembly as claimed in claim 4, wherein the hub is configured to permit the wheel to be secured by a central nut to the hub.

7. The wheel bearing assembly as claimed in claim 1, wherein the outer ring of the roller bearing arrangement is detachably fastened on the wheel carrier.

8. The wheel bearing assembly as claimed in claim 1, wherein the hub has an end face facing away from the wheel carrier, the end face being provided with a surface feature configured to provide a positive locking connection with a drive shaft for driving the wheel.

9. The wheel bearing assembly as claimed in claim 8, wherein the end face surface feature is a spur toothing.
